(19) United States
(12) Patent Application Publication
(10) Pub. No.: US 2004/0185332 A1
(43) Pub. Date: Sep. 23, 2004

(54) Tabs for electrochemical cells

(75) Inventor: Ernest D. Botos, Gainesville, FL (US)

Correspondence Address: Squire, Sanders & Dempsey L.L.P., Two Renaissance Square, Suite 2700, 40 North Central Avenue, Phoenix, AZ, 85004-4498, US

(73) Assignee: Moltech Corporation

(21) Appl. No.: 10/394,386

(22) Filed: Mar. 21, 2003

(51) Int. Cl. H01M 6/00

(52) U.S. Cl. 429/96

(57) ABSTRACT

Disclosed is a tab for use with an electrochemical cell. The tab is designed so that it can be replicated relatively easily in an automated manufacturing process and/or so it can be properly positioned on an electrochemical cell utilizing an automated process. The tab preferably includes a contact lead, a neutral lead and one or more contact strips connecting the contact lead and the neutral lead.

### TECHNICAL FIELD OF THE INVENTION

This invention relates to the field of electrochemical cells and more specifically to improved tabs for prismatic electrochemical cells.

### BACKGROUND OF THE INVENTION

In recent years the demand for high performance batteries has increased, driven in part by the increasingly large number of portable consumer electronics products. These products are moving away from the use of more traditional, cylindrical-shaped batteries to smaller, more compact batteries such as ones that utilize (flat) prismatic electrochemical cells. Prismatic cells are cells with polygonal side walls (such as parallelepiped or rectangular housings) and are found in many applications requiring high power densities, as their shape can provide high volumetric stacking efficiency in battery packs for use in portable electronic devices such as cellular phones, portable computers, digital cameras and the like. The batteries provide power to the electronic circuitry typically mounted on circuit boards that operate and control the portable electronic device.

A prismatic cell (the terms “electrochemical cell,” and “cell”, are used interchangeably herein) has at least two substantially parallel sides. One way of forming a prismatic cell is to first create a “jellyroll” (this term and structure being known to those skilled in the art) electrode stack and then compress the jellyroll stack to form the prismatic cell. To form a jellyroll electrode stack, a first anode layer 10 comprising an anode active material layer and an anode current collector layer, and a second layer 14 comprising a cathode active material layer and a cathode current collector layer, are positioned together with a separator layer 12 between the electrode layers to form a multilayer sandwich, as shown in FIG. 1a. In some embodiments the active material and the current collector are a single layer or are combined to form a single layer. For solid polymer electrolyte cells, the separator layer 12 is a polymer layer which functions as both an electrolyte and a separator. The electrode layers 10 and 14 may be offset in the sandwich such that the first layer 10 extends beyond the separator layer 12 on one edge of the sandwich and the second layer 14 extends beyond the separator layer 12 on the opposite edge of the sandwich, as shown in FIG. 1b. A length of this combined multi-layer sandwich is cut and then rolled (or rolled and then cut) (hence, a “jellyroll”) to form the jellyroll electrode stack. The jellyroll stack is then compressed to form a (flat) prismatic cell 101. The edges of the multi-layer sandwich comprising first layer 10, separator layer 12, and second layer 14, after rolling to form a jellyroll are termed ends of the electrode stack. Another way of forming an electrode stack for a prismatic cell is by a fan fold (or accordion fold) of an electrode layer sandwich as shown, for example in U.S. Pat. Pub. No. 2002/0160263A1. Yet another way of forming a prismatic cell is by stacking individual electrode layers as shown, for example, in U.S. Pat. Pub. No. 2002/0146620A 1. Further methods, for example, of prismatic cells are illustrated in the Handbook of Batteries, 2^{nd} edition, ed. D. Linden, chapter 36, page 40, McGraw-Hill, 1994.

The flat sides of the prismatic cell are essentially parallel to each other. FIG. 1c shows one of the flat sides 16 of a prismatic cell as well as a first end 18 and a second end 20. In FIG. 1c, one edge of the cathode layer and anode layer will be near to first end 18 and second end 20, respectively, such that tab connections may be attached to the current collector of each electrode layer either before, during, or after winding/stacking to provide a means to contact to an external circuit. The prismatic cell, with tabs, is placed in an enclosure, such as a rigid case or plastic bag. Typically, the enclosure has at least one open end from which the tab connections or tab contacts extend. The tabs may exit the enclosure one at each end. Alternatively, the contact tab of one of the tabs may be folded in such a way that both tab contacts exit the enclosure at an opening at one end. For cells having a liquid electrolyte the liquid electrolyte is then introduced into the enclosure, after which the enclosure is fully sealed. The formation of certain prismatic cells and the materials used in their formation are discussed in U.S. Pat. No. 6,190,426, entitled “Method of Preparing Prismatic Cells”, by Thibault et al. This patent in its entirety is incorporated herein by reference.

One difficulty in the preparation of prismatic cells is the connection of the tabs to the anode 10 and cathode 14 layers of the prismatic cell stack. During assembly of the prismatic cell the tabs may be attached either before, during, or after the prismatic cell is formed. The tabs are typically attached directly to the electrode active layer or to the current collector if one is used. When tabs are attached to the electrodes prior to winding the electrodes, for example by spot welding, difficulties can arise in the alignment of the tabs. This is especially true if multiple tabs to each electrode are used, which is especially important when long electrode lengths are used to provide the high energy drain necessary for advanced electronics.

With thin film lithium batteries, where either lithium foil or lithium deposited on a thin metallized plastic substrate is used, attachment of the tabs presents further problems. Methods such as spot welding are not readily useable for tab attachment at the end of electrode stacks from thin electrode layers, and the use of a single tab, for example inserted into the cell stack after winding as is known in the art, provides mediocre current collection and is undesirable due to the more complex automated manufacturing process required. Thus it becomes more difficult to achieve efficient current collection with a single tab or a small number of tabs from the electrodes when the electrodes have decreased thickness and are longer. More importantly it is highly desirable to have a continuous edge contact with both the cathode and anode electrodes along their entire length to provide the high energy drain required by advanced electronics. Attachment of tabs to very thin metal layers such as those of metallized plastic films is difficult particularly at the ends or edges of prismatic electrode stacks. For example, U.S. Pat. No. 5,415,954 to Gauthier et al. describes continuous edge contacting of a lithium metal anode with or without a separate substrate, in a lithium polymer electrolyte cell. Thibault et al., U.S. Pat. No. 6,190,426, describe both ultrasonic welding of lithium metal alloys and a metal spray process to form continuous edge contacting of both the cathode and anode. Disadvantages have been found with using a wide-angle metal spray process to fix the tabs to the current collectors as metal particles produced during the metal spray process can penetrate into the cell, causing electrical short circuits. Therefore, it would be an advantage to provide an improved tab design that overcomes one or more of these drawbacks, and allows for continuous edge contacting of long, thin, electrodes and specifically electrodes with thin metallized substrates and current collectors.

Prismatic cell design may be used with a number of choices of anode active materials and cathode active materials as are known to those skilled in the art. For example, lithium ion, lithium ion polymer, lithium metal polymer, nickel metal hydride, and lead acid cell chemistries may be fabricated in prismatic configurations, see for example Handbook of Batteries, 2^{nd} edition, ed. D. Linden, McGraw-Hill, 1994. Another type of cell chemistry suitable for use in prismatic cells is lithium-sulfur. In a lithium-sulfur cell the anode active layer comprises lithium and the cathode active layer comprises an electroactive sulfur-material, such as elemental sulfur, for example as described in U.S. Pat. No. 6,030,720 to Chu et al., U.S. Pat. No. 6,210,831 to Gorkovenko et al., and U.S. Pat. No. 6,302,928 to Xu et al.

The choice of electrolyte for use in prismatic cells is dependent on the choice of cathode and anode active materials. In general, since the electrolyte serves as a medium for the storage and transport of ions, any liquid, solid or gel material capable of storing and transporting ions may be used, so long as the material is electrochemically and chemically unreactive with respect to the cathode material and anode material. The electrolyte must also be electronically non-conductive to prevent shorting between the anode and the cathode. Different electrolytes for different anode and cathode materials are known in the art, see for example Nonaqueous Electrochemistry pp. 81-135, Ed. D. Aurbach, Marcel Dekker, 1999. For lithium-sulfur batteries, examples of liquid electrolytes include, but are not limited to, non-aqueous organic solvents such as, acetals, ketals, sulfones, aliphatic ethers, cyclic ethers, glymes, polyethers, dioxolanes, substituted forms of the foregoing, and blends thereof.

Suitable current collectors for the electrodes of prismatic cells include metallized plastic films, metal foils, metal grids, expanded metal grids, metal mesh, metal wool, woven carbon fabric, woven carbon mesh, non-woven carbon mesh, and carbon felt. Metal foils particularly well suited for current collectors are aluminum, copper, nickel, silver, gold or stainless steel. The selection is usually dictated by the conductivity requirements, the electrochemical inertness, the physical properties such as mechanical strength, and the cost factors involved. Current collectors may also be a metallized plastic film or sheet such as metallized polyester, metallized polyimide, metallized polyolefin, metallized vinyl sheet, and the like. If lithium foil is used as the anode active layer this may also function as the current collector.

### SUMMARY OF THE INVENTION

The present invention provides for improved tabs for use in prismatic electrochemical cells. In one embodiment, a tab for use on an electrochemical cell is disclosed. The tab comprises a contact lead, a neutral lead, and one or more contact strips connecting the contact lead and the neutral lead.

In another embodiment, an electrochemical cell having a prismatic design is disclosed. The cell includes an anode end and a cathode end, a first tab affixed to the anode end and a second tab affixed to the cathode end. Each tab comprises a contact lead of conductive material; a neutral lead of conductive material; and one or more contact strips connecting the contact lead and the neutral lead. In one embodiment, the neutral lead can be removed.

Additionally, a battery is disclosed. The battery comprises a casing and one or more electrochemical cells in the casing. Each of the cells comprises an anode end and a cathode end and a tab connected on the anode end, and a tab connected on the cathode end. Each tab comprises a contact lead, a neutral lead, and a plurality of contact strips connecting the contact lead and the neutral lead.

In another embodiment, methods for attaching the tabs to the ends of cells are disclosed.

### BRIEF DESCRIPTION OF THE DRAWINGS

Non-limiting and non-exhaustive preferred embodiments of the present invention are described herein, with like numbers indicating like parts and where:

FIG. 1a illustrates offset anode and cathode electrodes prior to winding into a jellyroll electrode stack;

FIG. 1b illustrates a side view of the offset anode and cathode electrodes;

FIG. 1c illustrates one embodiment of a wound jellyroll prismatic cell;

FIG. 2 illustrates an h-tab for an electrochemical cell;

FIGS. 3a and 3b illustrate the formation of an h-tab;

FIGS. 4a-4b illustrate the use of h-tabs with prismatic electrochemical cells;

FIG. 5 illustrates an electrochemical cell pinched by a nipper tool, and a metal spray device;

FIG. 6 illustrates a wiretab;

FIGS. 7a-7e illustrate steps in the formation of a wiretab;

FIG. 8 illustrates one method of attaching the wiretab to a prismatic cell;

FIG. 9 illustrates another method of fixing the wiretab to a prismatic cell;

FIG. 10 illustrates a novel nipper tool; and

FIG. 11 illustrates one method of insertion of a wiretab into a prismatic cell.

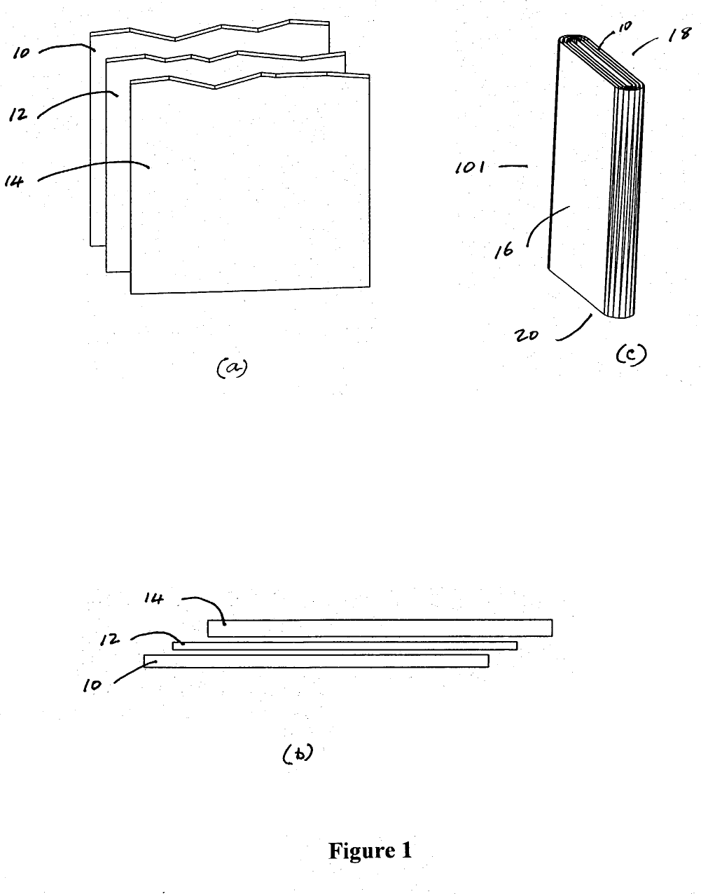

### DETAILED DESCRIPTION OF A PREFERRED EMBODIMENT

The following description references specific materials used in lithium-sulfur batteries. These descriptions are for exemplary purposes, it being understood that the invention as described is not limited to lithium-sulfur cells. The tabs according to the invention can be used with any compatible prismatic electrochemical cell. Examples include, but are not limited to, lithium ion cells, lithium metal polymer cells, nickel metal hydride cells, any polymer electrolyte cell as well as lithium-sulfur cells. The term electrochemical cell refers to a device that produces an electrochemical reaction and that contains a positive electrode (or cathode) and a negative electrode (or anode) and an electrolyte.

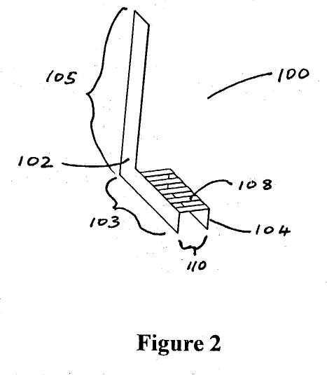

FIG. 2 illustrates an h-tab 100 for a prismatic electrochemical cell although the tab can be of any shape and dimension suitable for use as described herein. This tab configuration is called an h-tab because its profile resembles the lower case letter h. An h-tab 100 includes a contact lead 102 and a neutral lead 104. Contact lead 102 as shown is approximately “L” shaped (although it can be of any suitable shape) with a first contact portion 103 and a second contact portion 105 formed at essentially a right angle to the first contact portion 103. The contact lead 102 is shown as an “L” shape because that shape of contact lead 102, when the h-tab 100 is fixed to an end of a cell, allows the contact portion 105 of contact lead 102 to extend out from the cell. Neutral lead 104 and first contact portion 103 are preferably connected by one or more contact strips 108. In the case of multiple contact strips 108 there is a space between each contact strip 108. The number and thickness of the contact strips 108 depends on the current carrying capacity needed for the cell. Additionally, the contact strips 108 help protect the end of the cell from metal particle intrusion during the metal spray process used to attach the h-tab 100 to the electrode cell end. This will be discussed in greater detail below. Neutral lead 104 and first portion 103 are separated by a distance 110 that allows for placement over the end of the electrochemical cell on which it will be attached.

The material used to manufacture the h-tab 100 depends in part upon whether (1) the h-tab 100 will be used as a tab for a cathode or a tab for an anode, (2) the materials of which the cathode or anode are comprised including the active material, the current collector or electrode support, if present, and (3) the composition of other cell components such as the electrolyte. In a lithium-sulfur cell, the cathode tab may comprise aluminum, nickel, or inconel or similar materials compatible with the cell chemistry and the anode tab may comprise copper, nickel, or inconel or similar materials. Similar materials would be used for tabs in other kinds of prismatic cell chemistries, as are known in the art.

The thickness of the material, for example a foil or sheet, used to manufacture h-tab 100 can vary over a wide range, such as from 0.002 inches (0.05 mm) to about 0.015 inches (0.38 mm). In a preferred embodiment, the thickness is from about 0.003 inches (0.08 mm) to 0.01 inches (0.25 mm). The thickness chosen will depend on the current carrying capacity needed for the cell while keeping weight to a minimum, as well as manufacturability.

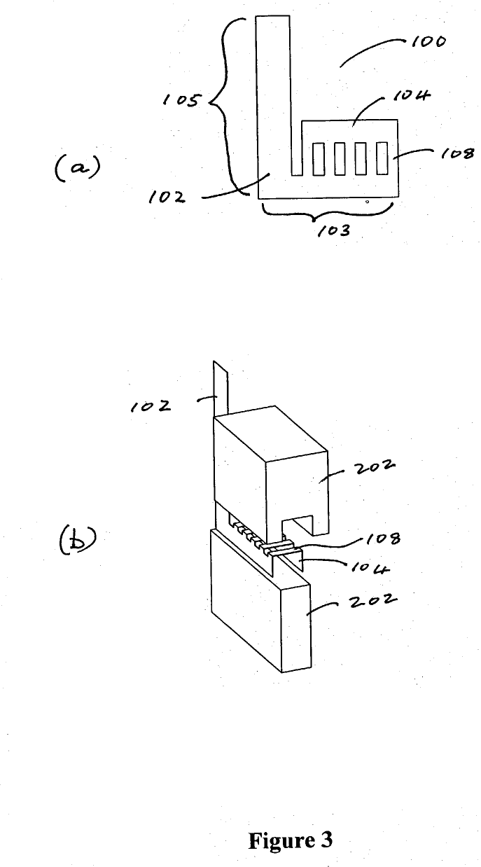

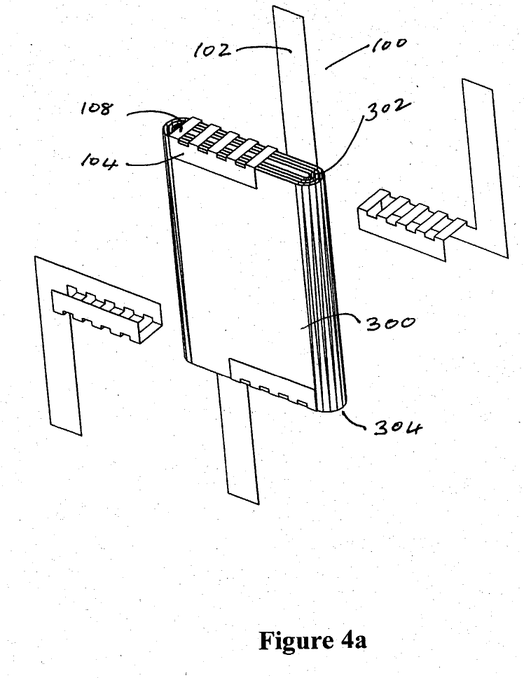

An h-tab 100 can be made in a punch and fold process, but any suitable process or technique may also be used. FIGS. 3a-3b generally illustrate one embodiment of the punch and fold process wherein an unfolded h-tab 100 is punched from a piece of metal, which is preferably aluminum or nickel for a cathode tab and copper or nickel for an anode tab. FIG. 3a illustrates an h-tab 100 as punched out from a piece of metal. After h-tab 100 is punched out, it can be further shaped by pressing it over a form, such as 2-part form 202 shown in FIG. 3b, although any suitable device or method may be utilized. The resultant shape is the “h” shaped tab 100 shown in FIG. 2.

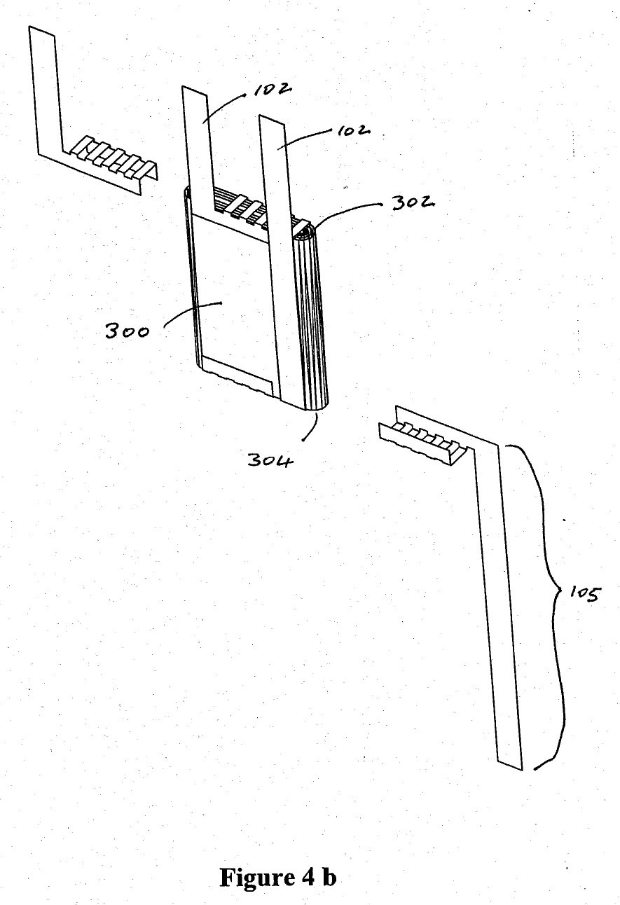

FIG. 4a illustrates the use of h-tab 100 with a prismatic electrochemical cell 300. Prismatic electrochemical cell 300 includes a cathode end 302 and an anode end 304. Prismatic electrochemical cell 300 is, in one embodiment, a lithium-sulfur cell, although as discussed previously, any electrochemical cell that can be constructed as a prismatic cell may be used with the present invention. In one method of making a prismatic cell, an anode layer comprising an anode active material and, optionally, an anode current collector, a separator, and a cathode layer comprising a cathode active material and, optionally, a cathode current collector, are wound around a mandrel of suitable shape as is known in the art to form a jellyroll and then compressed to form the electrode stack of a rounded, rectangular shape as shown in FIG. 4. The electrode stack may be formed by other methods known in the art, including but not limited to, accordion folding (fan folding), electrode sandwich stacking or bi-fold. The cathode layer and anode layer may be positioned in an overlapping manner such that the cell 300 has a cathode layer comprising a cathode active material and a cathode current collector at the cathode end 302 that can be connected to a first tab. At the anode end 304 the cell 300 has an anode layer comprising an anode active material and optionally an anode current collector that can be connected to a second tab. FIG. 4a illustrates an embodiment in which contact tabs 102 extend from opposite ends of the prismatic cell. An h-tab 100, made from a cathode compatible material such as aluminum or nickel, is placed over the cathode end 302 of cell 300 such that contact lead 102 is on a first side of cell 300, and neutral lead 104 is placed on a second side of cell 300 and contact strips 108 are positioned over the cathode end 302 of cell 300. FIG. 4b illustrates an embodiment in which contact leads 102 of the h-tabs extend from the same end of the prismatic cell. As illustrated in FIG. 4b the second contact portion 105 of the contact lead at the anode end 304 of cell 300 is lengthened to allow folding and thereby to extend from the cathode end 302 of the prismatic cell. Alternatively, the contact lead of the h-tab at the cathode end 302 of the cell 300 can be lengthened and folded to extend from the anode end 304 of the cell in conjunction with the anode tab.

The preferred method to connect h-tab 100 to cell 300 is by spraying a metal spray over h-tab 100 after it is placed on the cathode end 302. A metal spray is produced by a metal spray process, also known as a combustion wire thermal spray process. In a metal spray process, a metal, typically provided as a wire or powder, is melted and the liquid metal particles are sprayed on to the work piece using compressed air. The choice of metal to spray depends on the material used for the cathode. In a lithium-sulfur cell, aluminum can be used in the metal spray to connect the cathode tab. This connects contact strips 108 of h-tab 100 to the cathode current collector on the cathode end 302. The process is repeated for the anode end 304 of cell 300, where a second h-tab 100 is attached. To connect the h-tab 100 to the anode end 304, copper may be used as the metal for the metal spray.

One problem that may occur during the connecting (or adhering) of h-tab 100 to the cathode end 302 and anode end 304 of prismatic electrochemical cell 300 is that if metal spray is used and the cell 300 is incorrectly positioned, some of the particles of the metal spray may make their way between the electrode layers of the cell stack 300. The penetration of metal particles can cause shorts in the electrochemical cell 300, reducing the effectiveness of the cell 300 or inactivating the cell 300. The design of h-tab 100, with relatively wide contact strips 108 helps to block the metal spray from susceptible areas, thus helping to prevent metal particles from getting into unwanted areas of the cell 300.

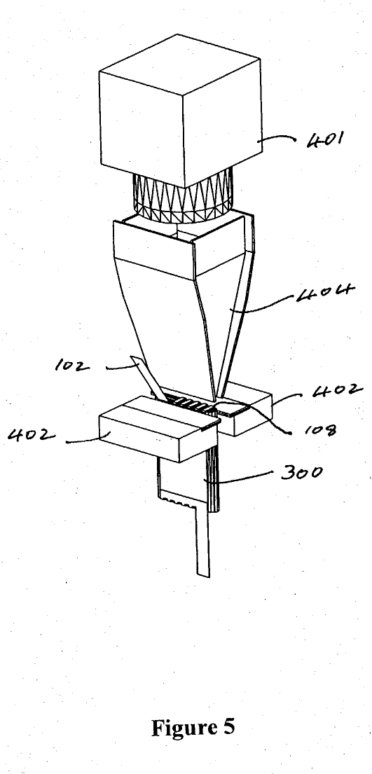

To further alleviate this problem, the cathode and anode ends 302 and 304 of electrochemical cell 300 can be nipped together while the metal spray is applied. Nipping the cathode and anode ends 302 and 304 together can help prevent metal particles from entering too deeply into the cell 300 and potentially causing an internal short or other problem. FIG. 5 illustrates an electrochemical cell 300 being nipped by a nipper tool 402. Although tool 402 is preferred to be used to nip the ends of cell 300, any suitable device or technique may be used. Nipper tool 402 compresses and deforms the end of electrochemical cell 300 compressing together the ends of the current collector electrode layers. The deformation caused by the nipper tool 402 helps to prevent any of the metal spray from entering between the electrode layers of cell 300. A spray funnel 404 is used to direct metal spray from the spray head 401 to a specific area on the ends 302 and 304 of electrochemical cell 300. Spray funnel 404 directs the spray to just the pinched ends 302 and 304 of cell 300. This is advantageous over the wide area metal spray used in conventional applications of metal spray because it uses less metal and reduces the amount of spray time. Directing spray using spray funnel 404 further helps to prevent spray over-penetration into cell layers of cell 300, as well as conserving spray material.

In one optional embodiment after the h-tab 100 is affixed to the ends of the prismatic cell 300, the neutral lead 104 is removed from contact strips 108 by any suitable means, for example by cutting. Removal of neutral lead 104 reduces cell weight, and hence improves energy density of the cell without impairment of the current carrying efficiency of the h-tab 100.

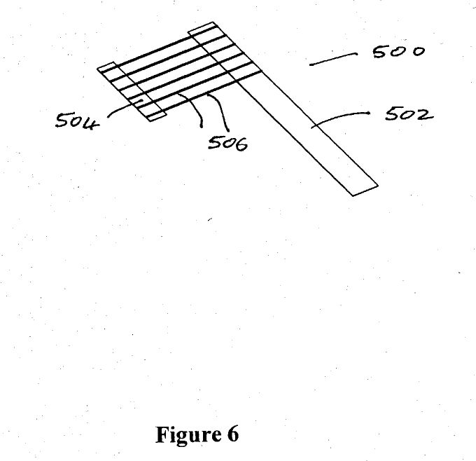

One drawback to the use of nipper tool 402 is that the contact strips 108 of h-tab 100 tend to deform due to the pressure exerted by the nipper tool 402. The deformation of the contact strips 108 moves the contact strips 108 away from the end 302 of the cell 300. This reduces the contact of the contact strips 108 of h-tab 100 with the conductive part of the ends of electrochemical cell 300 to which h-tab 100 is attached, which reduces the overall performance characteristics of electrochemical cell 300. To remedy this situation an alternate tab design, as shown in FIG. 6, may be utilized. FIG. 6 illustrates a wiretab 500 in accordance with the teachings of the present invention. Wiretab 500 includes a contact lead 502 and a neutral lead 504, which are preferably connected by a plurality of wires 506.

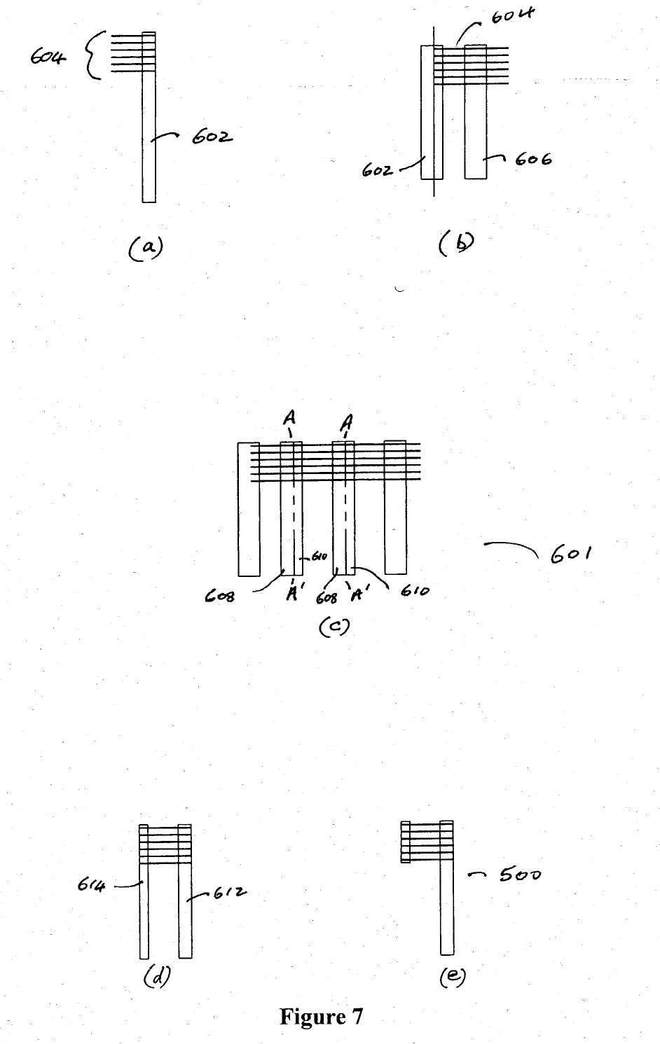

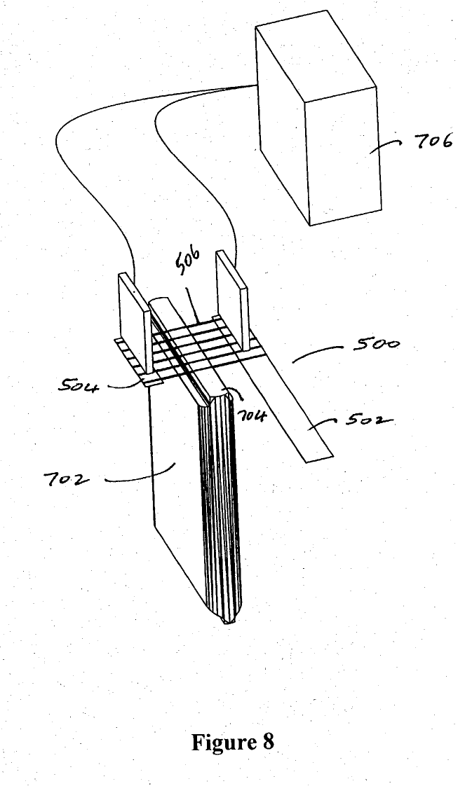

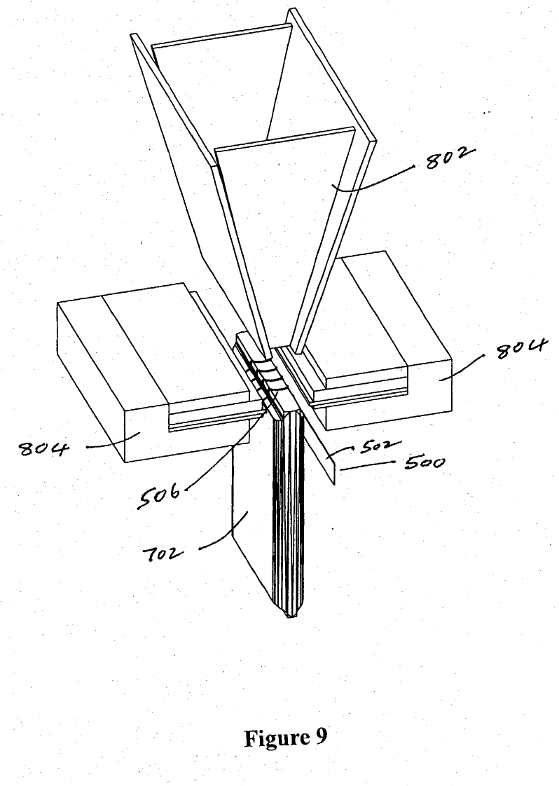

Contact lead 502 in this embodiment is preferably formed from an elongated piece of metal foil, the choice of metal depending on (1) whether the wiretab is to be used with the anode or cathode, and (2) the composition of the anode or cathode and other cell components. In a lithium-sulfur battery, the cathode tab may comprise aluminum, nickel, or inconel or similar materials and the anode tab may comprise copper, nickel, or inconel or similar materials. As illustrated the shape of contact lead 502 is rectangular. Other shapes for contact lead 502 can be used, including the “L” shape used for contact lead 102 of h-tab 100. However, in making preferred wiretab 500, contact lead 502 and neutral lead 504 are preferably cut from strips of foil as shown in FIGS. 7a-7e. It is typically easier to cut one rectangular portion than an “L” shaped portion. This is especially true if the material for the contact lead 502 and neutral lead 504 are provided on a roll of appropriate thickness. Neutral lead 504 is preferably made of the same material as contact lead 502, but is shorter in length. Neutral lead 504 is shorter because it does not need to extend beyond the cell ends.

Wires 506 are preferably made of the same material as the contact lead 502 and neutral lead 504, but may be of any wire capable of forming a suitable electrical connection with the current collector of the cell 704 (as seen in FIG. 8) and between contact lead 502 and neutral lead 504. Wires 506 are preferably used because they can be obtained in an appropriate size and can be easily attached to leads 502 and 504. However, any other thin metallic strip can be used. In one embodiment, wires 506 are 0.008 inches (0.2 mm) diameter aluminum wires for a cathode tab and 0.008 inches (0.2 mm) diameter copper wires for an anode tab in a lithium-sulfur prismatic cell of 800 mAh capacity and jelly roll electrode stack dimensions of 1.84×1.28×0.24 inches (46.7×32.5×6.1 mm). A range of wire diameters may be used, for example, from about 0.004 inches (0.1 mm) to 0.02 inches (0.51 mm), more preferably from about 0.005 inches (0.13 mm) to 0.015 inches (0.38 mm). The diameter used will depend on factors such as the desired current carrying capacity, ease of handling and availability. The choice of the composition of the wire depends on whether the tab is to be used as an anode tab or a cathode tab and the material used for the anode and cathode. For a lithium-sulfur battery, aluminum wire can be used for the cathode tab and copper or nickel wire used for the anode tab.

In one embodiment, there are one or more wires connecting contact tab 502 and neutral lead 504. In one embodiment, there are a total of six wires connecting contact tab 502 and neutral lead 504, but any suitable number of wires may be used. The choice of the number of wires and the diameter of the wires is determined by the current carrying capacity of the cell, the dimensions of the cell, and the number of contact points to minimize cell internal resistance. In one embodiment, wires 506 are ultrasonically welded to contact lead 502 and neutral lead 504, although any suitable method can be used to connect wires 506 to contact lead 502 and neutral lead 504 as long as good contact is made between the wires 506 and contact lead 502 and neutral lead 504. Ultrasonic welding is easily adapted to an automated manufacturing process.

As discussed previously, each h-tab 100 is preferably manufactured using a punch and form process. Wiretab 500, however, can be made by a different process, as illustrated in FIGS. 7a-7e. First as seen in FIG. 7a, a first strip of metal foil 602 is provided and a number of wires 604 are ultrasonically welded to first strip of metal foil 602. In this automated process, first strip of metal foil 602 with wires 604 ultrasonically welded to it is indexed, or otherwise moved from one position to another. Then, as illustrated in FIG. 7b, a second strip of metal foil 606 is provided and wires 604 are ultrasonically welded to the second strip of metal foil 606. This process is repeated to obtain a series of strips 601 of metal foil with wires ultrasonically bonded to it as illustrated in FIG. 7c. This process is readily adapted to prismatic cells of varying dimensions, for example by varying the separation distance between strips 601.

A cutting process is then used to separate individual tabs from the series of strips of metal foils. A cut is made along line A-A′ of FIG. 7c to separate individual tabs. In one embodiment, the cut along line A-A′ is uneven such that there is a first portion 608 of one width and a second portion 610 wherein the width of the first portion 608 is less than the width of the second portion 610. The portion with the greater width, second portion 610, will be the contact lead and the first portion 608 will be the neutral lead. These cuts are made at each strip 606 along the series of strips 601. FIG. 7d illustrates a single wiretab cut from the series of strips 601. In FIG. 7d the neutral lead 614 is longer than it needs to be since only one lead, contact lead 612, needs to be long enough to extend out from an enclosure to make contact with structures external to the cell. FIG. 7e illustrates a final wiretab 500 with the neutral lead trimmed down. The process of making wiretab 500 can be automated as described herein.

FIG. 8 illustrates one method of fixing wiretab 500 to a conductive support (or current collector) of an electrochemical cell 702. In FIG. 8, electrochemical cell 702 is a prismatic cell formed as discussed previously in conjunction with the cell shown in FIG. 3. In this embodiment, wiretab 500 is placed across one end 704 of cell 702. Wiretab 500 is heated using a wiretab heater 706. Wiretab heater 706 is any device capable of heating wiretab 500 to a high enough temperature that it makes permanent electrical contact with the conductive support of the anode active material or the conductive support of the cathode active material. In one embodiment, wiretab heater 706 passes an electrical current through wiretab 500. The wires 506 of wiretab 500 heat when a current is passed through the wires (due to resistive heating in the wires) and melt onto either the conductive support of the cathode active material or the conductive support of the anode active material (depending upon where wiretab 500 is positioned) to affix wiretab 500 and make electrical contact with either the conductive support of the cathode active material or the conductive support of the anode active material. While electrical heating of the wiretab 500 is one method for attaching wiretab 500 to cell 702, other heating methods such as thermal heating methods may also be employed. Additionally, while heating the wiretab 500 may be sufficient to affix wiretab 500 to cell 702, a heating process as discussed above, followed by a metal spray process may also be used. In this embodiment, the metal spray process can be applied for a shorter period of time than is used in the case of using metal spray alone to secure a tab. After wiretab 500 is affixed, the contact lead and neutral lead of wiretab 500 are folded down and tape is preferably applied to insulate or prevent sharp spray metal particles from puncturing the enclosure in which the cell will be placed. The tape can also act as strain relief for wiretab 500.

In another embodiment, wiretab 500 is affixed to a cell 702 by using metal spray from a metal sprayer similar to that discussed in conjunction with the h-tab 100. As shown in FIG. 9 a spray funnel 802 is preferably used to direct particles from the metal sprayer onto an end of electrochemical cell 702 with a wiretab 500 over it. The end of the electrochemical cell 702 is pinched by a nipper tool 804. Because the wires 506 in wiretab 500 are preferably thinner than the contact strips of h-tab 100, the wires 506 deform but the projected loop generated by the nip is easily bent to conform to the top end of the cell.

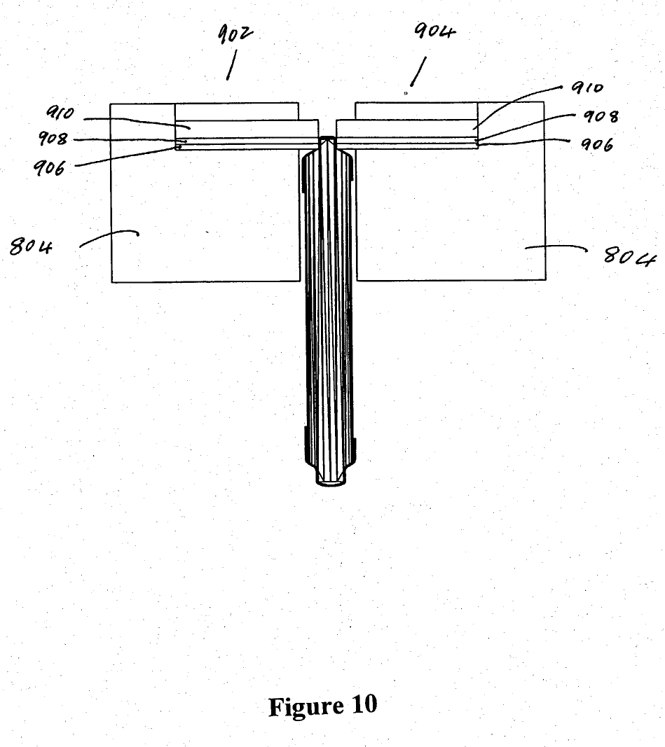

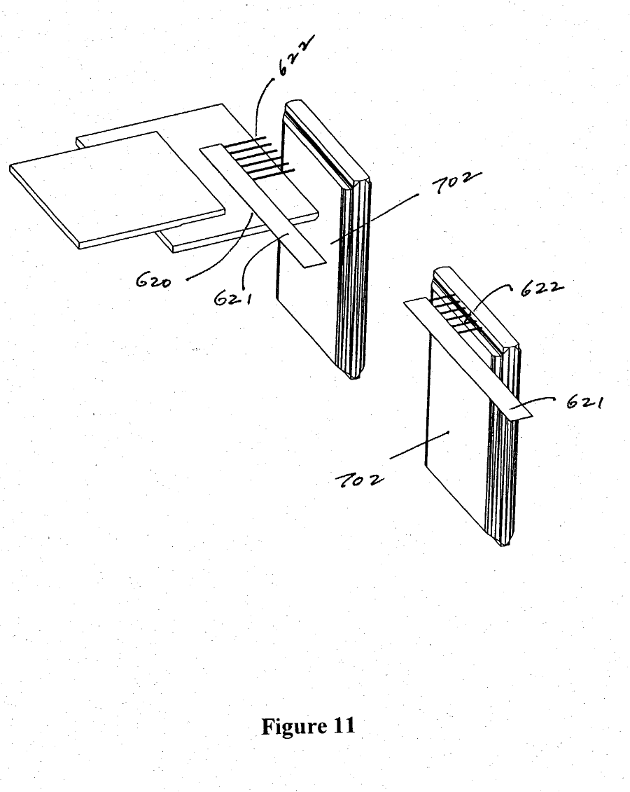

Nipper tool 804, shown in greater detail in FIG. 10, as used with the wiretab 800 can be of a special design to facilitate the spray process. Previous nipper tools used a first metal blade and a second metal blade on opposite sides of an electrochemical cell to contact the cell and pinch the top end of the cell. The metal blades contact the cell on the essentially flat, parallel sides of the cell as seen in FIG. 8. Contacting along the other sides would only expand the ends of the cell. The improved nipper tool 804 has a first side 902 and a second side 904. First side 902 contacts one side of a cell and the second side 904 contacts another side of the cell. The description of the structure of each side 902 and 904 of the nipper tool 804 will be the same since the components from each side is the same.

The first side 902 and second side 904 each have a first blade 906, a first resilient layer 908 and a second resilient layer 910. First blade 906 is preferably made of a metal that can contact a cell and be used to pinch the cell without damaging the cell, although any material that can be used to deform a cell without damage to that material can be used. An advantage of metal is that metals are good conductors of heat. During the metal spray process, the temperature of the cell increases due to the hot spray particles. A metal first blade 906 can help to remove heat from the wires and prevent the generation of high temperatures at the contact lead and neutral lead.

First resilient layer 908 is above first blade 906. First resilient layer 908 presses against the electrochemical cell at the pinched end and is specially designed to contact the wires 506 of wiretab 500. The first resilient layer holds the wires 506 in place and seals around the wires 506. This helps to secure the wires against the cell while preventing deformation of the wire 506, which could lead to poor contact with the ends of the cell. In one embodiment, first resilient layer 908 is made from high temperature silicone rubber, although any high temperature resilient material may be used. One advantage of silicone rubber is that the metal spray does not readily adhere to silicone rubber, therefore the nipper tool can be cleaned easily.

Second resilient layer 910 does not extend as far as first resilient layer 908 and first blade 906. Thus, second resilient layer 910 does not contact the electrochemical cell. Instead, second resilient layer forms a cavity for the spray in the area where the metal spray is needed at the end of the cell. In conjunction with the focused spray from the spray funnel, the cavity formed by the second resilient layer 910 helps to prevent overspray and keep the spray located near the ends of the cell.

In one embodiment (optionally) after wiretab 500 is affixed to the ends of prismatic cell 702, neutral lead 504 is removed from contact wires 506 by any suitable means, for example by cutting. Removal of neutral lead 504 reduces cell weight without impairment of the current carrying efficiency of the tab.

In another embodiment, wiretab 620 comprises contact lead 621 and contact wires 622 as illustrated in FIG. 11a. In this embodiment there is no neutral lead. This results in a lighter tab, which helps improve the energy density of the cell. FIG. 11b illustrates one method of attaching wiretab 620 to a conductive support (or current collector) of an electrochemical cell. The method comprises the mechanical insertion of the contact wires 622 through the conductive support of the electrochemical 702. Although this wiretab and method of attachment may be used with a variety of prismatic cells, it is particularly suited to the attachment of a wiretab to the lithium metal anode end of a prismatic cell. The diameter of the wires useful as contact wires in the wiretab 620 may vary widely but must have sufficient strength to pierce the conductive support in the attachment process. Suitable diameter for copper wires for attachment of a copper wiretab to a lithium metal anode depends on the thickness of the electrode stack and is from about 0.006 inch (0.15 mm) to about 0.015 inch (0.38 mm). In one embodiment, the diameter of the copper wire for contact wires of wiretab 620 is from 0.008 inch (0.2 mm) to 0.01 inch (0.25 mm).

Having now described preferred embodiments of the invention, alterations and modifications that do not depart from the spirit of the invention may occur to those skilled in the art. The invention is thus not limited to the preferred embodiments but is instead set forth in the appended claims and legal equivalents thereof. For example, the present invention can be used with any compatible prismatic electrochemical cell. Examples include lithium ion cells, lithium solid polymer electrolyte cells, nickel metal hydride cells, any polymer electrolyte cell as well as lithium-sulfur cells.

What is claimed:

1. A tab for use on a prismatic electrochemical cell, the tab for providing an electrical contact and comprising:
(a) a contact lead;
(b) a neutral lead; and
(c) one or more contact strips connecting the contact lead and the neutral lead.

2. The tab of claim 1 wherein the neutral lead is removable after connecting the tab to a prismatic electrochemical cell.

3. The tab of claim 1 wherein the tab is a cathode tab manufactured from a metal from the group consisting of aluminum, nickel, and inconel.

4. The tab of claim 1 wherein the tab is an anode tab manufactured from a metal from the group consisting of copper, nickel, and inconel.

5. The tab of claim 1 wherein the one or more contact strips comprise one or more metal wires.

6. The tab of claim 5 wherein the metal wires are ultrasonically welded to the neutral lead and to the contact lead.

7. The tab of claim 1 wherein the contact lead is L-shaped and the tab is h-shaped.

8. A prismatic electrochemical cell having a cathode end and an anode end, and tabs connected to the cathode end and the anode end, each tab comprising:
(a) a contact lead;
(b) a neutral lead; and
(c) one or more contact strips connecting the contact lead and the neutral lead.

9. The tab of claim 8 wherein the neutral lead is removable.

10. The cell of claim 8 wherein each tab is connected using a metal spray process.

11. The cell of claim 8 wherein the ends of the electrochemical cell and the tabs are pinched with a nipper tool, and are sprayed with a metal spray after being nipped.

12. The cell of claim 11 wherein the nipper tool comprises a nipper blade for deforming the electrochemical cell, a first resilient layer for holding the contact strips in place and a second resilient layer for forming a spray cavity.

13. The cell of claim 10 wherein a spray funnel is used to direct the metal spray.

14. The cell of claim 8 wherein the one or more contact strips comprise one or more wires.

15. The cell of claim 14 wherein the one or more wires are ultrasonically welded to the neutral lead and the contact lead.

16. The cell of claim 14 wherein the tab is heated such that when applied to either the cathode end or anode end the tab will make contact with a current collector.

17. The cell of claim 16 wherein the tab is heated using a tab heater that passes an electrical current through the tab.

18. The cell of claim 17 wherein a metal spray process is used after heating the tab to further connect the tab to the cathode end and anode end.

19. The cell of claim 8 wherein the cathode tab is manufactured from a metal from the group consisting of aluminum, nickel, and inconel.

20. The cell of claim 8 wherein the anode tab is manufactured from a metal from the group consisting of copper, nickel, and inconel.

21. The cell of claim 8 wherein the contact lead is L-shaped and the tab is h-shaped.

22. The cell of claim 8 wherein the anode end comprises an anode active layer comprising lithium and a cathode active layer comprising an electroactive sulfur material.

23. A battery comprising:
(a) a casing; and
(b) one or more electrochemical cells in the casing, wherein each of the cells comprises:
(i) an anode end and a cathode end;
(ii) a tab on the anode end, and a tab on the cathode end wherein each tab comprises:
(A) a contact lead;
(B) a neutral lead; and
(C) one or more contact strips connecting the contact lead and the neutral lead.

24. The battery of claim 23 wherein the cell further comprises an electrolyte.

25. The battery of claim 23 wherein the anode end comprises an anode active layer including lithium and the cathode end comprising a cathode active layer including an electroactive sulfur material.

26. A tab for use on a prismatic electrochemical cell, the tab for providing an electrical contact and comprising:
(a) contact lead; and
(b) two or more contact strips attached to the contact lead.

27. The tab of claim 26 wherein the two or more contact strips comprise two or more metal wires.

28. The tab of claim 26 wherein the two or more metal wires are inserted into an anode end of an electrochemical cell.

29. A prismatic electrochemical cell having a cathode end and an anode end, and tabs connected to the cathode end and the anode end, the anode tab comprising:
(a) a contact lead; and
(b) two or more contact strips attached to the contact lead.

30. The cell of claim 29 wherein the two or more contact strips of the anode tab comprise two or more metal wires.

31. The anode tab of claim 30 wherein the tab is connected to the anode end of the cell by inserting the contact strips of the tab through the end of the cell.
